(19) United States
(12) Patent Application Publication
(10) Pub. No.: US 2006/0018218 A1
(43) Pub. Date: Jan. 26, 2006

(54) Method and apparatus for increasing the ability of decoding a land pre-pit

(75) Inventors: Seng-Ming Chuang, Taipei City (TW); Yung-Yu Chang, Taipei City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/185,849

(22) Filed: Jul. 21, 2005

(30) Foreign Application Priority Data
Jul. 23, 2004 (TW) 093122192

(51) Int. Cl. G11B 7/00

(52) U.S. Cl. 369/47.1; 369/44.27; 369/59.1

(57) ABSTRACT

A method and apparatus for increasing the ability of decoding a land pre-pit are disclosed. The steps of the method include providing a host for executing an interface seek command. A seeking servo action is generated by the interface seek command. A first pre-pit slicing level is regulated to make the seeking servo action decode an absolute position. A tracking servo action starts from the absolute position. A second pre-pit slicing level is regulated to make the tracking servo action decode a target position.

### BACKGROUND OF THE INVENTION

1. Field of the Invention

The present invention relates to a method for increasing the ability of decoding a land pre-pit, and more particularly to the method for increasing the ability of decoding a land pre-pit by means of adjusting the pre-pit slicing level.

2. Description of the Prior Art

A DVD (Digital Versatile Disc) has energetically been researched and developed because the DVD is a recording medium which is capable of recording information in a greater quantity than that recorded on a typical CD.

Referring to FIG. 1, a cross-sectional perspective view of a typical DVD of minus format (for example, DVD Recordable, DVD-R) is shown. The DVD-R2 includes lands 4 and pre-grooves 6. The pre-grooves 6 are regions on which information, such as video data and audio data, must be recorded as recording pits. Moreover, DVD-R has land pre-pits (hereinafter called LPP, not shown) formed on lands 4 which are regions formed among the pre-grooves. The LPP contain address information of the DVD-R. In other words, an absolute address of the DVD-R is recorded on the LPP. An optical pickup should decode the LPP in order to know the position where the optical pickup is located above the DVD-R. Because of deviation in the process of manufacturing the DVD-R, the amplitudes of the LPP for all kinds of the DVD-R are not identically. Especially for rewritable discs, such as the DVD-RW, the amplitudes of the LPP on some positions of the rewritable discs are smaller due to the manufacturing process, or become smaller due to erode by the recording power and rewritable times. Accordingly, a pre-pit slicer with fixed slicing level may not be able to slice a correct LPP. Thus, a decoder may not decode a pre-pit information correctly so as to cause a failure of the recording action.

Presently, disc drives are without functions for solving these questions about different amplitudes of the LPP between different kinds of discs. The cost and time are too much of a waste for customers to use these disc drives. The present invention supplies a method and apparatus for increasing the ability of decoding a land pre-pit to solve above-mentioned questions.

### SUMMARY OF THE INVENTION

Accordingly, it is one objective of the present invention to provide a method for increasing the ability of decoding a land pre-pit to solve the question of different kinds of discs with different amplitudes of land pre-pits. A characteristic of the method is to adjust the pre-pit slicing level to slice to correctly decode the land pre-pit. Decoding correct land pre-pit information could avoid the wrong message and the failure of the recording action.

It is another objective of the present invention to supply an apparatus for increasing the ability of decoding a land pre-pit to solve the question of wasting the cost and time for recording information on the discs. The invention could decode the correct land pre-pit information by way of adjusting the pre-pit slicer without changing the design of the hardware.

In order to achieve above-mentioned purposes, a method for increasing the ability of decoding a land pre-pit is disclosed. The method includes providing a host for executing an interface seek command. A seeking servo action is generated by the interface seek command. A first pre-pit slicing level is regulated to make the seeking servo action decode an absolute position. A tracking servo action starts from the absolute position. A second pre-pit slicing level is regulated to make the tracking servo action decode a target position.

### BRIEF DESCRIPTION OF THE DRAWINGS

The present invention can be best understood through the following description and accompanying drawings wherein:

FIG. 1 is a cross-sectional perspective view of a typical DVD-R.

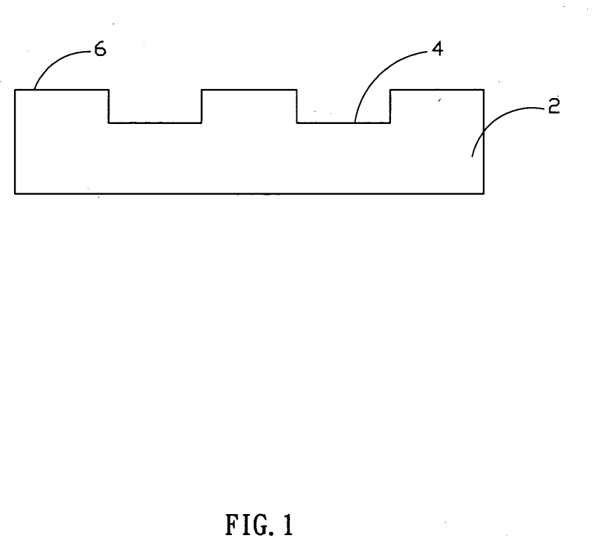

FIG. 2 is a flow chart of the embodiment of the present invention.

FIG. 3 is a schematic diagram of the embodiment of the present invention.

FIG. 4 is a block diagram of the embodiment of the present invention.

### DESCRIPTION OF THE PREFERRED EMBODIMENT

Some embodiments of the present invention have detailed descriptions below. However, except for the detailed descriptions, the present invention can have a broad use in other embodiments, and the scope of the present invention can not be defined by this preferred embodiment, but by the appended claims.

In the preferred embodiment, a method for increasing the ability of decoding a land pre-pit is disclosed. The method includes providing a host for executing an interface seek command. A seeking servo action is generated by the interface seek command. A first pre-pit slicing level is regulated to make the seeking servo action decode an absolute position. A tracking servo action starts from the absolute position. A second pre-pit slicing level is regulated to make the tracking servo action decode a target position.

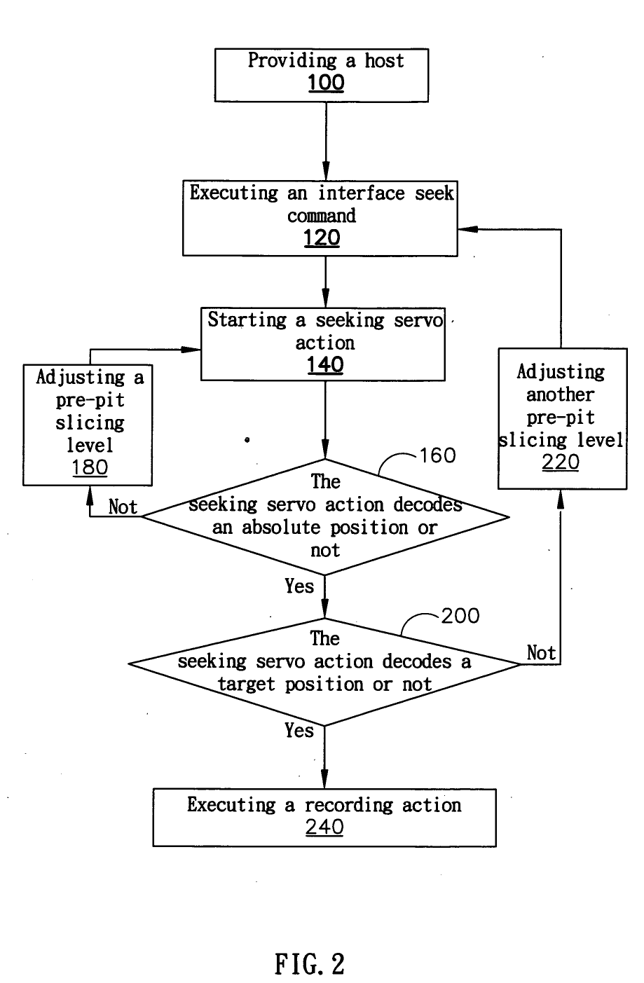

Referring to FIG. 2, the preferred embodiment of the present invention is a flow chart of increasing the ability of decoding a land pre-pit by adjusting a pre-pit slicing level. The steps of the flow chart include providing a host (step 100). An interface seek command is executed by the host (step 120). A seeking servo action is generated by the interface seek command (step 140). The seeking servo action is checked to decide whether the optical pickup is located on an absolute position or not (step 160). If not, a pre-pit slicing level is adjusted (step 180). The steps 140 and 160 are repeated again. If the optical pickup is located on the absolute position, the seeking servo action is checked to decide whether the optical pickup is located on a target position or not (step 200). If not, another pre-pit slicing level is adjusted (step 220). The steps 120, 140, 160 and 180 are repeated again. If the seeking servo action decodes the target position, i.e. the optical pickup is located on the target position, the recording action is executed (step 240). Herein the flow path from step 180 through step 140 to step 160 is not limited by the number of times but limited by a predetermined time. In other words, the flow path proceeds to decode the absolute position in the predetermined time. In the same way, the flow path from step 220 through steps 120, 140, 160 to step 200 also is not limited by the number of times but limited by the time. In other words, the flow path proceeds to decode the target position in the limited time. Besides, the absolute position in step 160 means that a position of the LPP is located on the disc before the target position. The absolute position generally has a distance from about one to three tracks before the target position, thus a tracking servo action is generally executed so as to locate the optical pickup on the target position (at the same time the optical pickup can decode the LPP of the target positions. The target position is a starting position for the host to read or record the information on the disc. In addition, the method of adjusting the pre-pit slicing level in the step 180 and step 220 could be set in many ways, such as that the range of the slicing level is preset to divide into 30 levels. One of the 30 levels could be selected in each time of adjusting the pre-pit slicing level. The present invention is not limited in this embodiment. Besides, the pre-pit slicing level in the step 180 may be the same or may be different with one in the step 220.

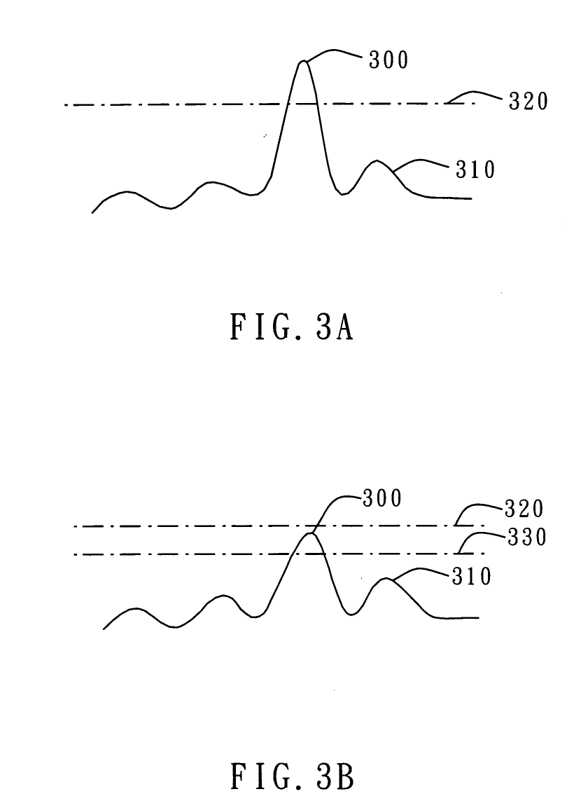

Referring to FIG. 3, the preferred embodiment of the present invention is a schematic diagram for increasing the ability of decoding a land pre-pit by adjusting a pre-pit slicing level. FIG. 3A is a waveform diagram of a normal signal of the LPP and FIG. 3B is a waveform diagram of an abnormal signal of the LPP. The amplitude of a land pre-pit signal 300 in FIG. 3B is smaller than one in FIG. 3A. The reason which causes the amplitude of a land pre-pit signal 300 to be smaller may be that the amplitude of the land pre-pit formed during manufacturing is smaller or severe temperature variation during the recording action so as to erode the amplitude of the land pre-pit. The smaller amplitude of the land pre-pit would reduce the amount of light reflection and then the light detector receives a smaller light signal so as to produce a smaller land pre-pit signal 300. The amplitude of the land pre-pit signal 300 in FIG. 3A is a larger difference than one of the noise 310, so as to slice the land pre-pit signal 300 easily by the slicing level 320 with a fixed position. If the above-mentioned reason makes the land pre-pit signal 300 smaller as depicted in FIG. 3B, the slicing level 320 with fixed position could not slice the land pre-pit signal 300 correctly. At this moment, the method of the present invention is used to adjust the slicing level 320 to lower the slicing level 330 so as to easily slice the land pre-pit signal 300.

During the seeking of the target position of the disc, if LPP could not be decoded, the seeking action of the absolute position or the target position fails. In this situation, the optical drive would return to seek the absolute position of the disc again. One characteristic of the present invention is to adjust the slicing level of the pre-pit slicer in this moment to check whether the next seeking process succeeds or not. If not, the slicing level is adjusted again and then the absolute position of the disc is sought until success.

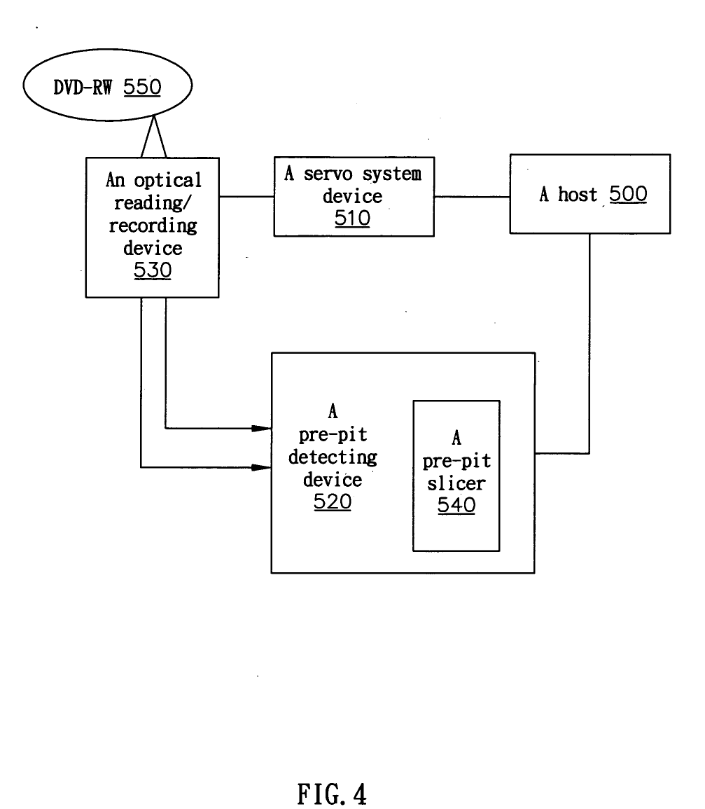

FIG. 4 is a block diagram showing the general structure of an optical drive apparatus according to the embodiment. The apparatus includes a host 500, a servo system device 510, a pre-pit detecting device 520, and an optical reading/recording device 530, herein the pre-pit detecting device 520 contains a pre-pit slicer 540, a amplifier, a comparator, and a decoder. When the host 500 sends a seek command to the servo system device 510, the servo system device 510 would drive the DVD-RW disc 550 and the optical reading/recording device 530. The optical reading/recording device 530 would collect the reflective light from the DVD-RW disc 550 and transform the reflective light to electrical signal. Then, the pre-pit detecting device 520 detects the electrical signal. After amplifying and comparing the electrical signal, the absolute position of the LPP on the DVD-RW disc 550 is decoded. When the pre-pit detecting device 520 could not decode the absolute position of the LPP on the DVD-RW disc 550, the slicing level of the pre-pit slicer 540 is adjusted by means of the method of the present invention to decode the absolute position of the LPP.

Above said preferred embodiment is only used to illustrate the present invention, not intended to limit the scope thereof. Many modifications of the preferred embodiment can be made without departing from the spirit of the present invention.

What is claimed is:

1. A method for improving decoding capability of position on a storage medium, said method comprising:
providing a host to execute an interface seek command;
starting a seeking servo action controlled by said interface seek command;
adjusting a first pre-pit slicing level to make said seeking servo action decode an absolute position;
starting a tracking servo action from said absolute position; and
adjusting a second pre-pit slicing level to make said tracking servo action decode a target position.

2. The method of claim 1, further comprising proceeding a recording action from said target position.

3. The method of claim 1, further comprising proceeding a reading action from said target position.

4. The method of claim 1, wherein the step of adjusting said first pre-pit slicing level comprises:
adjusting said first pre-pit slicing level to restart said seeking servo action on condition that said seeking servo action fails in decoding said absolute position; and
checking whether said seeking servo action decodes said absolute position.

5. The method of claim 4, wherein the step of adjusting said first pre-pit slicing level proceeds until said seeking servo action decodes said absolute position.

6. The method of claim 4, wherein said first pre-pit slicing level varies with adjusting of said adjusting step.

7. The method of claim 1, wherein the step of adjusting said second pre-pit slicing level comprises:
adjusting said second pre-pit slicing level to restart said interface seek command on condition that said tracking servo action fails in decoding said target position;
starting said seeking servo action, wherein said seeking servo action is controlled by said interface seek command;
adjusting said first pre-pit slicing level to make said seeking servo action decode said absolute position;
starting said tracking servo action from said absolute position; and
checking whether said tracking servo action decodes said target position.

8. The method of claim 7, wherein the step of adjusting said second pre-pit slicing level proceeds until said tracking servo action decodes said target position.

9. The method of claim 8, wherein said second pre-pit slicing level varies with adjusting of said adjusting step.

10. The method of claim 1, wherein said first pre-pit slicing level is same as said second pre-pit slicing level.

11. The method of claim 1, wherein said first pre-pit slicing level is different from said second pre-pit slicing level.

12. An apparatus for improving decoding capability of position on a recording medium, said apparatus comprising:
a host configured to execute an interface seek command;
a servo system device configured to start a seeking servo action and a tracking servo action, wherein said seeking servo action and said tracking servo action are controlled by said interface seek command;
an optical reading/recording device controlled by said servo system device; and
a pre-pit detecting device used to adjust a first pre-pit slicing level to make said seeking servo action decode a absolute position of said recording medium and to adjust a second pre-pit slicing level to make said tracking servo action decode a target position of said recording medium.

13. The apparatus of claim 12, wherein said optical reading/recording device proceeds a recording action from said target position.

14. The apparatus of claim 12, wherein said optical reading/recording device could proceed a reading action from said target position.

15. The apparatus of claim 12, wherein the step of adjusting said first pre-pit slicing level comprises:
adjusting said first pre-pit slicing level to restart said seeking servo action on condition that said seeking servo action fails in decoding said absolute position; and
checking whether said seeking servo action decodes said absolute position.

16. The apparatus of claim 15, wherein the steps of adjusting said first pre-pit slicing level proceeds until said seeking servo action decode said absolute position.

17. The apparatus of claim 16, wherein said first pre-pit slicing level varies with adjusting of said adjusting step.

18. The apparatus of claim 12, wherein said the steps of adjusting said second pre-pit slicing level comprises:
adjusting said second pre-pit slicing level to restart said interface seek command on condition that said tracking servo action fails in decoding said target position;
starting said seeking servo action, wherein said seeking servo action is controlled by said interface seek command;
adjusting said first pre-pit slicing level to make said seeking servo action decode said absolute position;
starting said tracking servo action from said absolute position; and
checking whether said tracking servo action decodes said target position.

19. The apparatus of claim 18, wherein the steps of adjusting said second pre-pit slicing level proceeds until said tracking servo action decodes said target position.

20. The apparatus of claim 19, wherein said second pre-pit slicing level varies with adjusting of said adjusting step.

21. The apparatus of claim 12, wherein said first pre-pit slicing level is same as said second pre-pit slicing level.

22. The apparatus of claim 12, wherein said first pre-pit slicing level is different from said second pre-pit slicing level.

23. The apparatus of claim 12, wherein said pre-pit detecting device comprises a pre-pit slicer.
